(19) United States
(12) Patent Application Publication
(10) Pub. No.: US 2012/0302206 A1
(43) Pub. Date: Nov. 29, 2012

(54) SURFACE SOFTWARE AND ASSOCIATED METHODS

(76) Inventors: Curtis A. VOCK, Niwot, CO (US); Adrian LARKIN, (US); Perry YOUNGS, Mead, CO (US)

(21) Appl. No.: 13/482,122

(22) Filed: May 29, 2012

Related U.S. Application Data
(60) Provisional application No. 61/490,943, filed on May 27, 2011.

(51) Int. Cl. H04W 4/26; G06F 3/048

(52) U.S. Cl. 455/406; 715/764

(57) ABSTRACT

A system and method control display of information to prevent information overload and distraction of a user. Information for display is monitored, analyzed, prioritized, and then presented to the user in a controlled manner. The system and method further process the data to track and bill time based upon activity of the user.

### RELATED APPLICATIONS

This application claims priority to U.S. Patent Application Ser. No. 61/490,943, filed May 27, 2011, which is incorporated herein by reference.

### BACKGROUND

Windows based personal computers (PCs) allow the user to simultaneously connect to and view a plurality of information providing services, such as e-mail servers (e.g., corporate email servers), social networking servers (e.g., Facebook™), blogging servers (e.g., Twitter™), webmail servers (e.g. YahooMail™, GMail™), search engines, news servers (e.g., RSS feeds), Instant Messaging (IM) servers (e.g., Jabber™), photo servers (e.g., Shutterfly™, Flikr™), and a plurality of informational web sites (e.g., Wikipedia™). The amount of information available to users is overwhelming. The human brain, although advanced as compared to other animals, can still only assimilate limited amounts of information when presented simultaneously. One recent paper suggests that more than seven pieces of data cannot be assimilated easily, such that degraded performance results when more than seven items are presented simultaneously.

Typically, computer users simultaneously connect to many information sources that each provide multiple pieces of information with real-time updates. For example, an email program may display all recently received emails and update the display, with an optional sound, each time a new email is received for the user. Similarly, an IM server may display messages received from multiple people and immediately display, optionally with a sound, new messages when received for the user.

Where a service obtains financing from advertising (e.g., free services such as email, photos, and IM), the generated display often contains one or more advertisements. Each advertisement typically includes features (e.g., flashing, color, movement, content, etc.) that attempt to get more of the user's attention than the other advertisements; thus, advertisements are particularly distracting for the user. The user's experience is often totally dictated by advertising.

Although, in certain circumstances, advertising may be welcomed by a user, there are other times when it is an unwanted distraction. For example, when informational sources are accessed in a working environment, work productivity is usually reduced because of unwanted information and distractions; often to the point where a company blocks such services entirely from their computer systems.

### SUMMARY OF THE INVENTION

The disclosure herein involves software and hardware that cooperate to transform the amount of data received through a display such as a computer screen, tablet PC or smart phone. Specifically, people today receive too much information. There are articles written about individual information overload and how too much information limits the ability to make wise choices. See, e.g., Newsweek, I Can't Think, 27 Feb. 2011. The technology of this disclosure can function simply to reduce the amount of data a person is exposed to, for example by removing entirely unwanted or rarely used newsfeeds or advertisements, leaving more pristine, important data to review and enjoy.

The idea is to control what is actually shown on the screen. You interpret social networking information and filter it so only stuff you care about shows up. You delete all ads. It is like a screen dump—it captures the image but manipulates the image quickly so what you see is filtered in desirable ways. You remove unwanted data leaving only “quality” data and prioritize to show it in smaller pieces—that match the 7 item limit of human short term memory. The system still allows interaction with the information sources, and everything is experienced correctly. In an embodiment, the surface software “interprets” what you like and what you don't like in social networking information or any application and automatically ignores the stuff you don't spend time on. This is the ultimate control of user experience.

In another embodiment, Surface Software cooperates with a social network server such that a user's experience on multiple devices is shared and consistent. Specifically, the social network receives and shares information from surface software application running on many different devices, thereby building comprehensive and powerful profiles that may be used by other devices running surface software applications. In certain embodiments, the surface software application and associated functionality are built into communication devices such that the user's experience is automatically configured for that device. Further, the social network server may determine the current status and environment of the user, and thereby configure the surface software accordingly. For example, where the user arrives at a particular location, such as their place of word or a restaurant, each surface software application associated with the user may be appropriately configured for operation at that location at that particular time (i.e., based upon the user current status).

### BRIEF DESCRIPTION OF THE FIGURES

FIG. 1 shows an exemplary prior art display of information received from a plurality of information sources.

FIG. 2 shows one exemplary surface software (SS) service for simplifying presentation of information from one or more information sources for easy human assimilation, in an embodiment.

FIG. 3 shows one exemplary system for controlling display of information from one or more information sources within a computer, in an embodiment.

FIG. 4A shows exemplary functionality of the SS service of FIG. 2 and the SS application of FIG. 3 when generating the flattened information screens, in an embodiment.

FIG. 4B is a flowchart illustrating one exemplary process for generating a flattened display, in an embodiment.

FIGS. 5A and 5B shows one exemplary system for limiting display of information, in an embodiment.

FIG. 6 shows one exemplary system for limiting display of information, in an embodiment.

FIG. 7 shows one exemplary display rendered from the graphical signal output of the graphics port of the processor box of FIG. 5A.

FIG. 7A shows one exemplary output screen from the graphics port of the processor box of FIGS. 5A and 5B by the surface software application, in an embodiment.

FIG. 8 shows one exemplary graphical process for detecting information within the graphical signal from graphics port of the system of FIGS. 5A and 5B, in an embodiment.

FIG. 9 is a flowchart illustrating one exemplary process for generating a flattened display shown in FIG. 7A, in an embodiment.

FIG. 10 shows one exemplary configuration wherein a Surface Software application is installed on multiple devices and cooperates with a social networking server, in an embodiment.

### DETAILED DESCRIPTION OF THE EMBODIMENTS

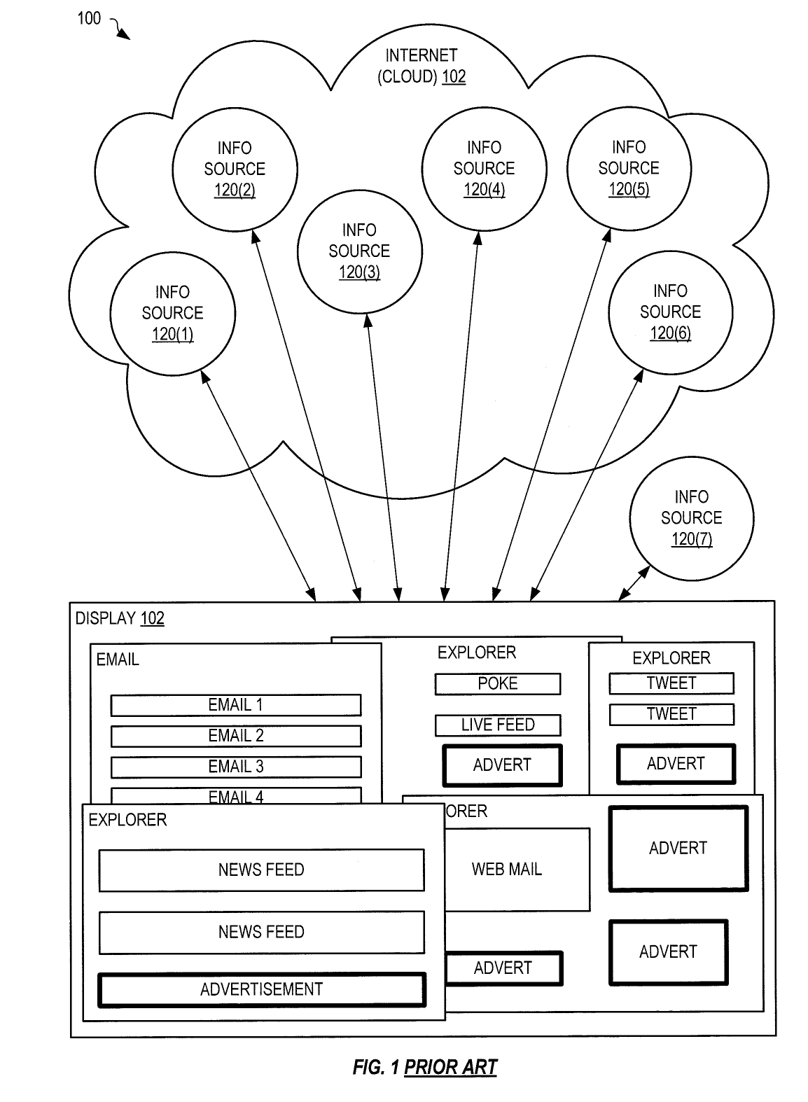

FIG. 1 shows an exemplary prior art display of information received from a plurality of information sources. A user of a personal computer (PC) typically opens multiple windows, at least one for each of a plurality of information sources, such as applications, web pages (web sites), cloud services, folder lists, and so on. As shown in FIG. 1, a display (or multiple displays) of the PC may appear very cluttered and difficult to assimilate.

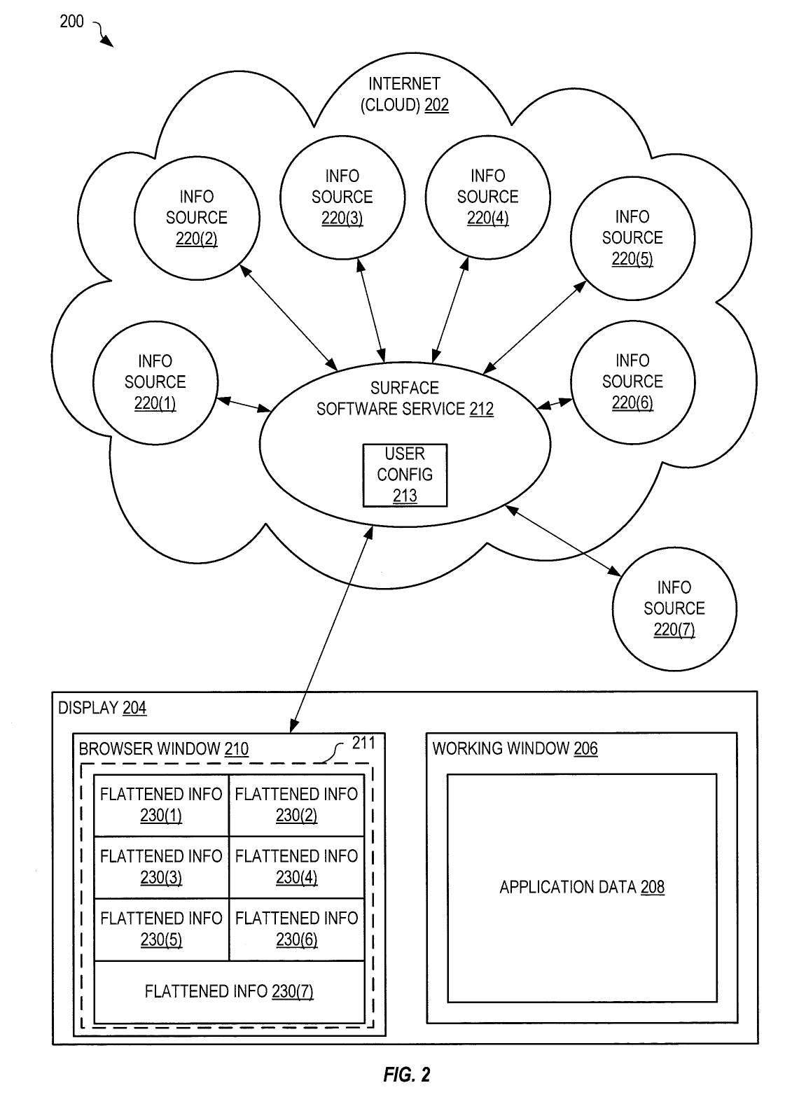

FIG. 2 shows one exemplary surface software (SS) service 212 for simplifying presentation of information from one or more information sources for easy human assimilation. SS service 212 is shown within Internet (cloud) 202 and is accessed via Internet 202 using a browser for example running on a PC. In the example of FIG. 2, a PC display 204 shows a browser window 210 that contains a flattened and simplified data presentation.

Based upon a user configuration 213, SS service 212 connects to a plurality of information sources 220 to receive information desired by the user. Information sources 220 are accessed via Internet 202, and may be cloud based services and corporate sources of information. For example, information source 220(1) may represent an instant messaging (IM) service, information sources 220(2) and 220(3) may represent social networking servers (e.g., Facebook™, Twitter™), information source 220(4) may represent a webmail service (e.g., Yahoo™ Mail, GMail™), information source 220(5) may represent a search engine (e.g., Google™), information source 220(6) may represent a news server (e.g., Comcast™ News Server), and information source 220(7) may represent a corporate email server. User configuration 213 may define one or more URLs for each information source 220, together with a set of rules that define filters and a priority of the information received from the information source.

SS service 212 filters, orders, and limits information from information sources 220 to generate a flattened and controlled information display 211 for display on the user's PC within browser window 210. PC display 204 may contain other data, and is illustratively shown with a working window 206 that contains application data 208. Working window 206 may represent a display from a word-processing application, for example. By flattening and controlling information presented to the user within controlled information display 211, SS service 212 prevents continuous distractions to the user that typically result from display of information from information sources 220, and also keeps the PC display 204 from becoming overly cluttered with unwanted and unnecessary information. Since SS service 212 also control the update rate of flattened information 230 presented to the user, user distraction is minimized, allowing the user to concentrate on application data 208 without undue distraction.

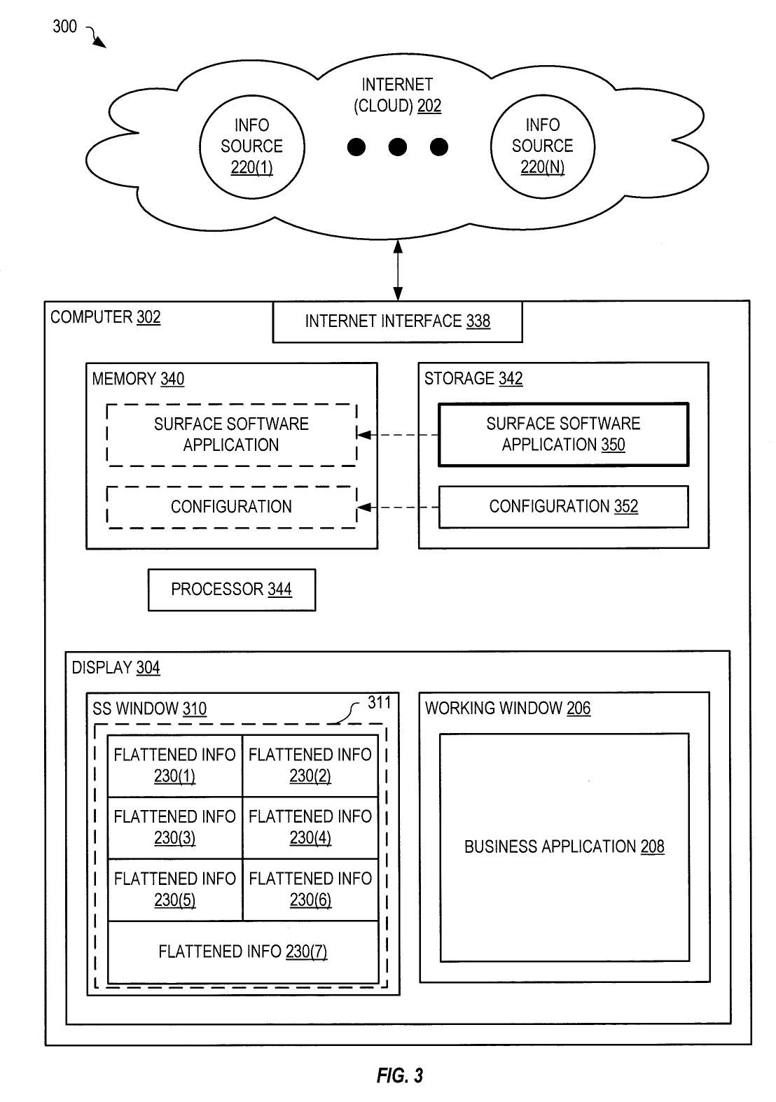

FIG. 3 shows one exemplary system 300 for controlling display of information from one or more information sources 220 within a computer 302. Computer 302 has an Internet interface 338, a display 304, a memory 340, storage 342, and a processor 344. Storage 342 stores an SS application 350 that is loaded into memory 340 and executed by processor 344. Function of SS application 350 is similar to SS service 212 of FIG. 2. SS application 350 connects to one or more information sources 220 within Internet 202 via Internet interface 338 of computer 302 and provides display screen 311 based upon configuration 352.

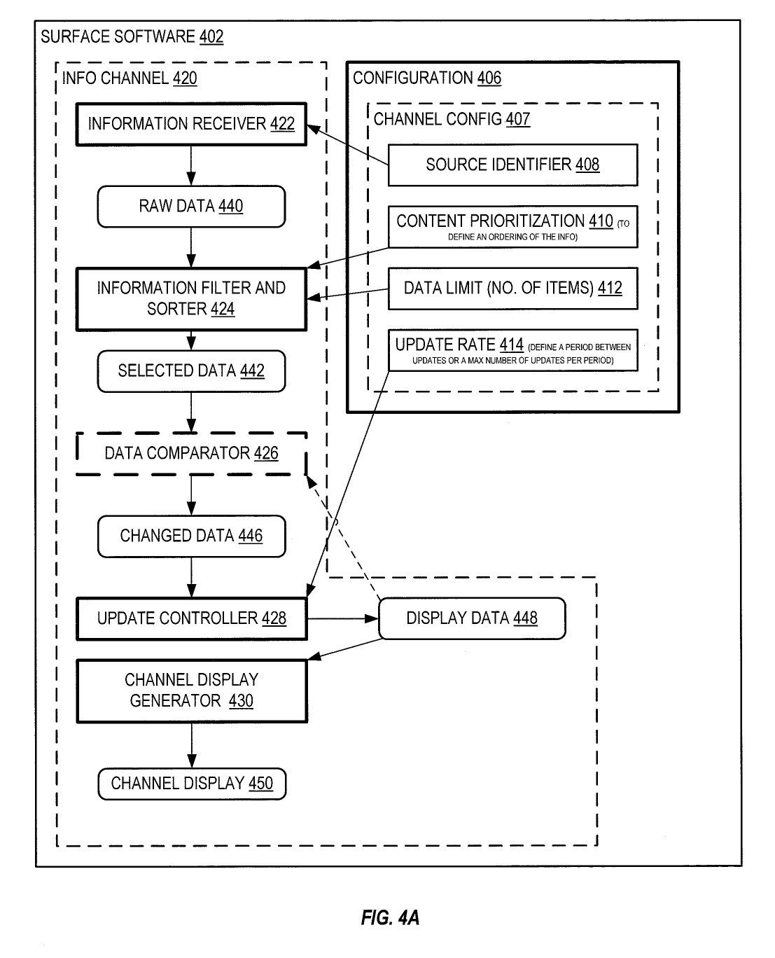

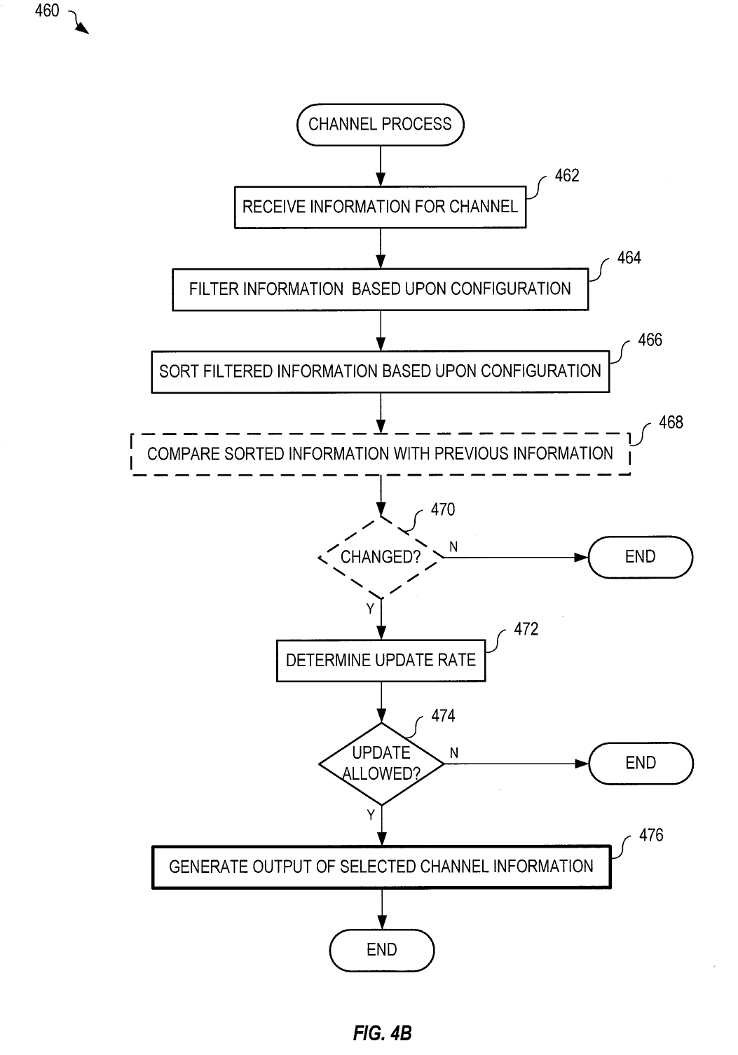

FIG. 4A shows exemplary functionality of SS 402 that may represent functionality of SS service 212 of FIG. 2 and SS application 350 when generating flattened information screen 211 and 311, respectively. SS 402 processes raw data 440, received from an information source, through an information channel 420 to generate a channel display 450. SS 402 includes one information channels 420 for each information source 220. SS 402 includes a configuration 406 that includes a channel configuration 407 for each information channel 420.

Each information channel 420 includes an information receiver 422, an information filter and sorter 424, a data comparator 426, an update controller 428 and a channel display generator 430. Information receiver 422 connects to one information source 220, identified by source identifier 408 of channel configuration 407, to receive raw data 440 therefrom. Information filter and sorter 424, based upon content prioritization 410 and data limit 412 of channel configuration 407, processes raw data 440 to produce selected data 442 that contains prioritized, sorted and limited information from information source 220. A user may define source identifier 408 and content prioritization 410, such that SS 402 present information of interest and relevance to the user. The user any have more than one configuration 406 that is selected based upon a status of the user. For example, is the user is at work, configuration 406 may be defined to restrict and prioritize information relevant to the user's work. When at home, the user may switch to a ‘home’ configuration such that SS 402 presents information of interest and relevant to the user's current home environment. In one example, the “work” configuration is implemented and imposed by the user's office policies, thereby restricting the user's access to irrelevant information.

A data comparator 426 compared selected data 442 with previous display data 448 to determine changed data 446. Update controller 428 determines whether changed data 446 contains new information and, based upon an update rate 414 of configuration 406, determines whether display data 448 may be updated with this new information. For example, update rate 414 may define a period such that update controller 428 allows updates to occur once per that defined period. Channel display generator 430 takes display data 448 and generates channel display 450 that may form at least part of information displayed to the user.

FIG. 4B is a flowchart illustrating one exemplary process 460 for generating a flattened display. Process 460 is for example implemented within SS 402 of FIG. 4A. In step 462, process 460 receives information for a channel. In one example of step 462, information receiver 422 receives raw data 440 from one information source 220 identified by source identifier 408 of configuration 406.

In step 464, process 460 filters the received information based upon the defined configuration. In step 466, process 460 sorts the filtered information based upon the configuration. In one example of steps 464 and 466, SS 402 reads content prioritization 410 and data limits 412 of configuration 406 and filters and sorts raw data 440 to produce selected data 442.

Step 468 and 470 are optional. If included, step 468 compares the sorted information with sorted information of the previous iteration. In one example of step 468, data comparator 426 compares selected data 442 with display data 448 and generates changed data 446. Changed data 446 includes information that is selected (filtered and sorted) from the information source and has recently changed. Step 470, if included, is a decision. In step 470, if the information has changed, process 460 continues with step 472; otherwise process 460 terminates.

In step 472, process 460 determines an update rate for the information channel Step 474 is a decision. If, in step 474, process 460 determines that updates are allowed, process 460 continues with step 476; otherwise, process 460 terminates.

In one example of steps 472 and 474, SS 402 reads update rate 414 from configuration 406 to determine whether the changed information should be displayed based upon a time of a previous one or more updates. In one embodiment, updates are restricted to defined periods, such as “break time” or “lunch time” at work. In another example, update may occur at a rate of one per 10 minute period, wherein SS 402 stores the changed information for output. In another embodiment, processing of each information channel 420 occurs only at a defined time.

In step 476, process 460 generates output selected channel information. In one example of step 476, channel display generator 430 of SS 402 generates channel display 450 from display data 448.

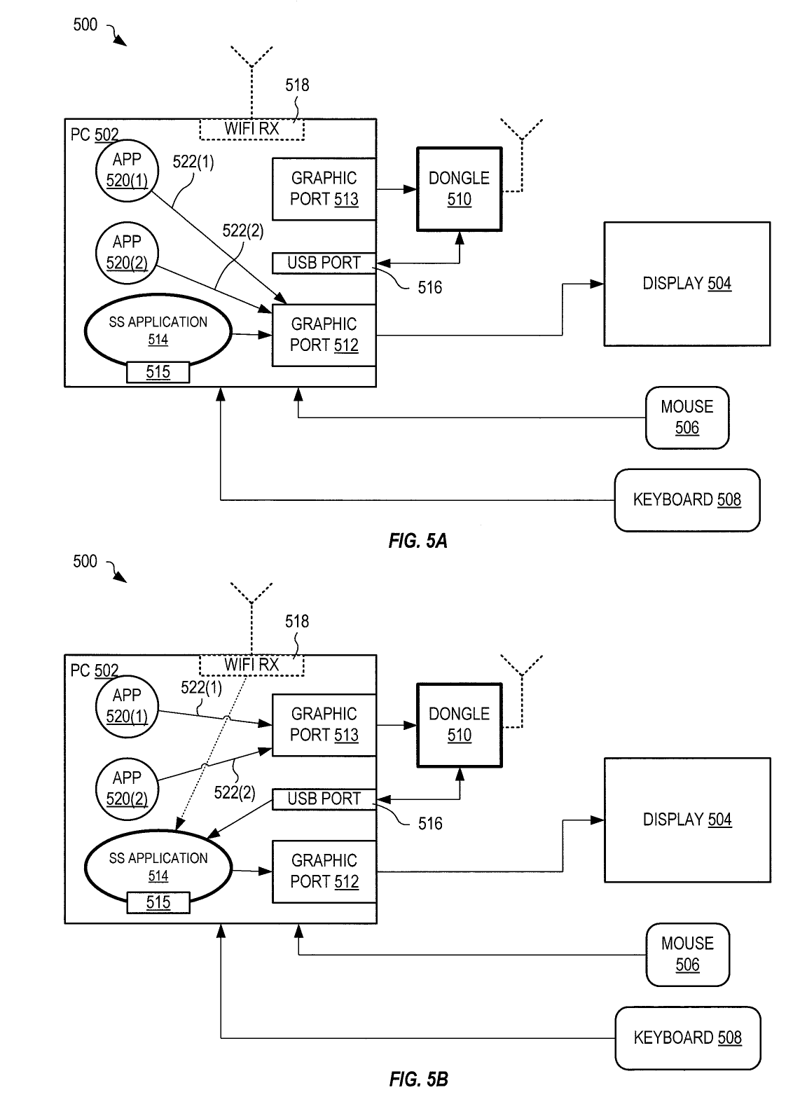

FIGS. 5A and 5B show one exemplary system 500 for limiting display of information, in an embodiment. System 500 is a personal computer (PC) having a processor box 502, a display 504, a mouse 506, a keyboard 508, and a dongle 510. Processor box 502 includes a processor, memory, and storage, as known in the art, which are not shown for clarity of illustration. A user of processor box 502 may run one or more applications 520 that generate graphical output via a graphics port 512. For example, graphics port 512 may output a graphical signal (e.g., HDMI, composite video, VGA, XVGA etc.) for display on display 504. Dongle 510 connects to a second graphic port 513 and operates to process information displayed on graphic port 513. Dongle 510 may use one or moth of a USB port 516 and a wireless communication port 518 to communicate with an SS application 514. Wireless communication port 518 is for example a WI-Fi-interface. During initialization, as shown in FIG. 5A, applications 520 output information for display on graphic port 512. Once system 500 is initialized, as shown in FIG. 5B, applications 520 are reconfigured to output display information to graphic port 513. Dongle 510 processes graphic information from graphic port 513 and sends the processed graphic information to SS application 514 via one or both of USB port 516 and wireless communication port 518. SS application 514 then reforms (flattens) the information from dongle 510 and presents this information on display 504 via graphic port 512. SS application 514 and dongle 510 thereby cooperate to limit display of information on display 504, thereby preventing the user of system 500 from becoming overloaded and/or distracted.

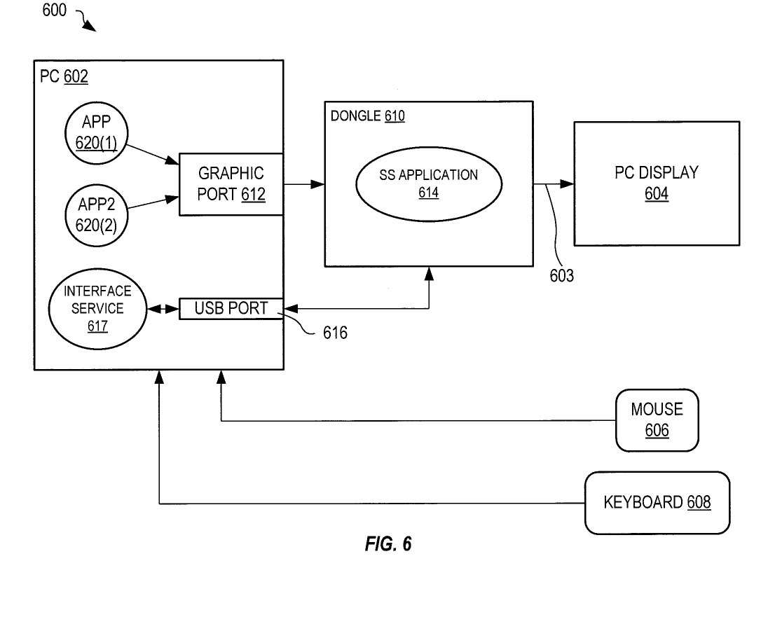

FIG. 6 shows one exemplary system 600 for limiting display of information, in an embodiment. System 600 is a personal computer (PC) having a processor box 602, a display 604, a mouse 606, a keyboard 608, and a dongle 610. Processor box 602 includes a processor, memory, and storage, as known in the art, which are not shown for clarity of illustration. Similar to the system of FIGS. 5A and 5B, a user of processor box 602 may run one or more applications 620 that generate graphical output via a graphics port 612. For example, graphics port 612 may output a graphical signal (e.g., HDMI, composite video, VGA, XVGA etc.) for display on display 604. Dongle 610 includes a processor, memory, and communication interfaces (not shown for clarity of illustration) that cooperate to execute SS application 614. SS application 614 processing graphical information from graphic port 612 and operates to reduce complexity (e.g., to flatten) the information and generates a second graphical signal 603 to drive display 604 to display the information to the use with reduced complexity. Processor box 602 may include an interface service 617 that provides user input (e.g., as input via mouse 606 and/or keyboard 608) to SS application 614 running on dongle 610 via USB port 616. Other means for communication service information to SS application 614 may be used without departing from the scope hereof.

Thus, as shown in the embodiment of FIG. 6, dingle 610 may be added to an existing computer (e.g., processor box 602) to provide information processing and control (through SS application 614) without the need to add a second graphic port to processor box 602. In one embodiment, dongle 610 includes a switch that allows the user to disable dongle 610 and/or bypass SS application 614, wherein output from graphic port 612 is passed directly to display 604.

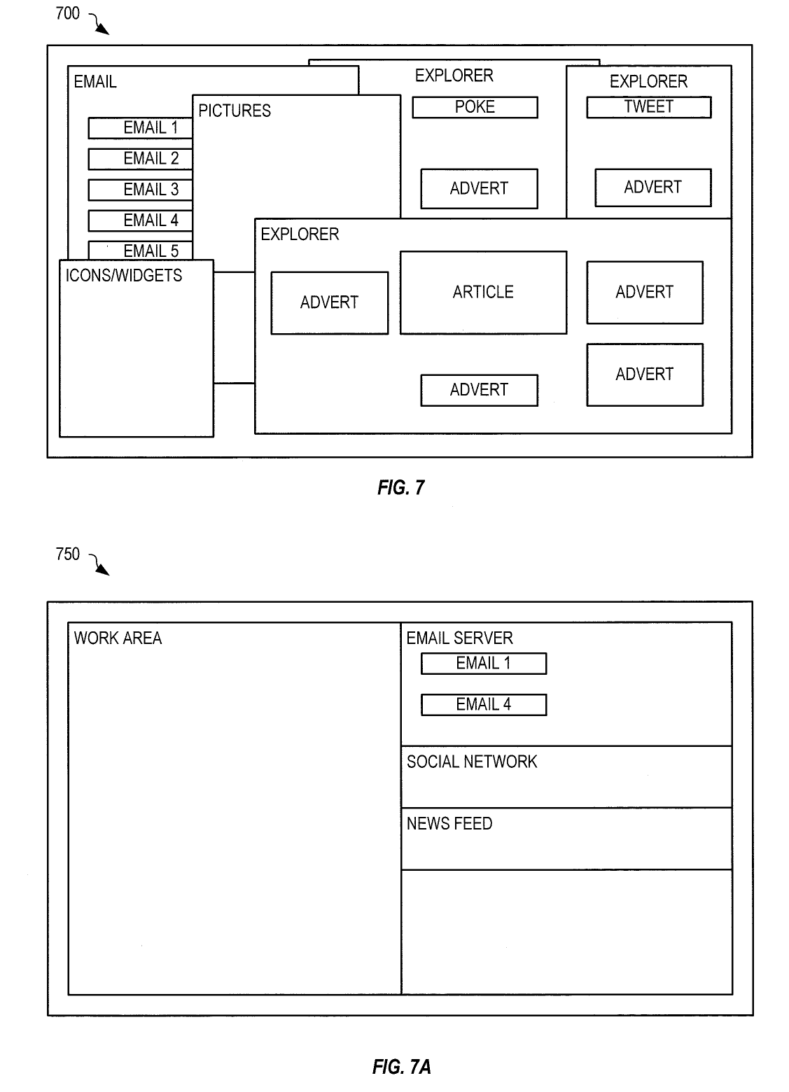

FIG. 7 shows one exemplary display 700 that may be rendered from the graphical signal output from graphics port 512 of processor box 502. Display 700 includes output from multiple applications 520 that each receives information from one or more information sources (e.g., information sources 220). As previously described, the information from information sources 220 includes advertisements, and other information that is of no interest to the user, resulting in a cluttered screen that is difficult for the user to assimilate.

SS application 514 runs within processor box 502 to detect when the user runs applications 520 that access information sources 220. SS application 514 automatically switches displayed windows of applications 520 to a second graphics port 513 such that information within these windows is captured by dongle 510 and sent to SS application 514. Dongle 510 connects to second graphic port 513 of processor box 502 and processes a graphical output signal from graphics port 513. In one embodiment, graphics ports 512 and 513 a controlled by a graphics adapter, not shown. In another embodiment, graphics ports 512 and 513 are controlled by separate graphics adapters, not shown.

SS application 514 receives the windows and content information from dongle 510, for example via a USB port 516 of processor box 502 and/or an optional Wi-Fi communication ability. For example, dongle 510 may communicate with SS application 514 via wireless communication port 518 of processor box 502. SS application 514 then determines at least part of information received by application 520 for display on display 504 to the user based upon configuration 515. User configuration 515 may be similar to configuration 406 of FIG. 4A.

FIG. 7A shows one exemplary output screen illustrating a work area, used by applications such as word processors, spreadsheets, etc, and a plurality of controlled areas for email, social network information, news feeds, etc, that are managed by SS application 514.

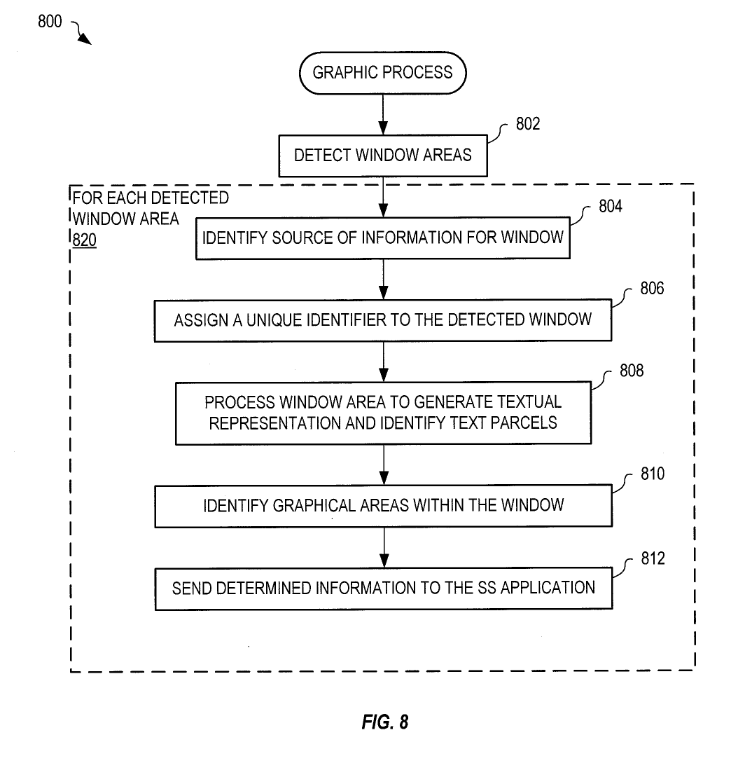

FIG. 8 shows one exemplary graphical process 800 for detecting information within the graphical signal from graphics port 512. Process 800 may operate within dongle 510. In step 802, process 800 detects window areas within the graphical signal. In one example of step 802, dongle 510 detects rectangular shaped areas within the graphical output signal from graphic port 512. Steps 804 through 810 then process each detected window of step 802.

In step 804, process 800 identifies a source of information within the detected window. In one example of step 804, a window title area is identified by dongle 510 and an OCR is used to determine a possible source of information displayed within the window. In another example of step 804, dongle 510 uses graphical image recognition to identify an icon or logo within the detected window.

In step 806, process 800 assigns a unique identifier to the detected window. In one example of step 806, dongle 510 utilizes a unique number, for example determined from a predefined sequence such as a counter, to identify the detected window.

In step 808, process 800 processes the detected window area to generate textual information representation of the information visible within the window. In one example of step 808, dongle 510 utilizes OCR to create a textual representation of information displayed within the window.

In step 810, process 800 detects graphical areas within the detected window. In one example of step 810, dongle 510 determines coordinates, relative to the detected window, of graphical areas within the window.

In step 812, process 800 sends the determined information to the SS application. In one example of step 812, dongle 510 sends the determined window information, the identified source of information for the window (if any), and the textual representation of the window, and any coordinates of graphical areas that appear within the detected window, to SS application 514 via USB port 516, and/or wireless communication port 518.

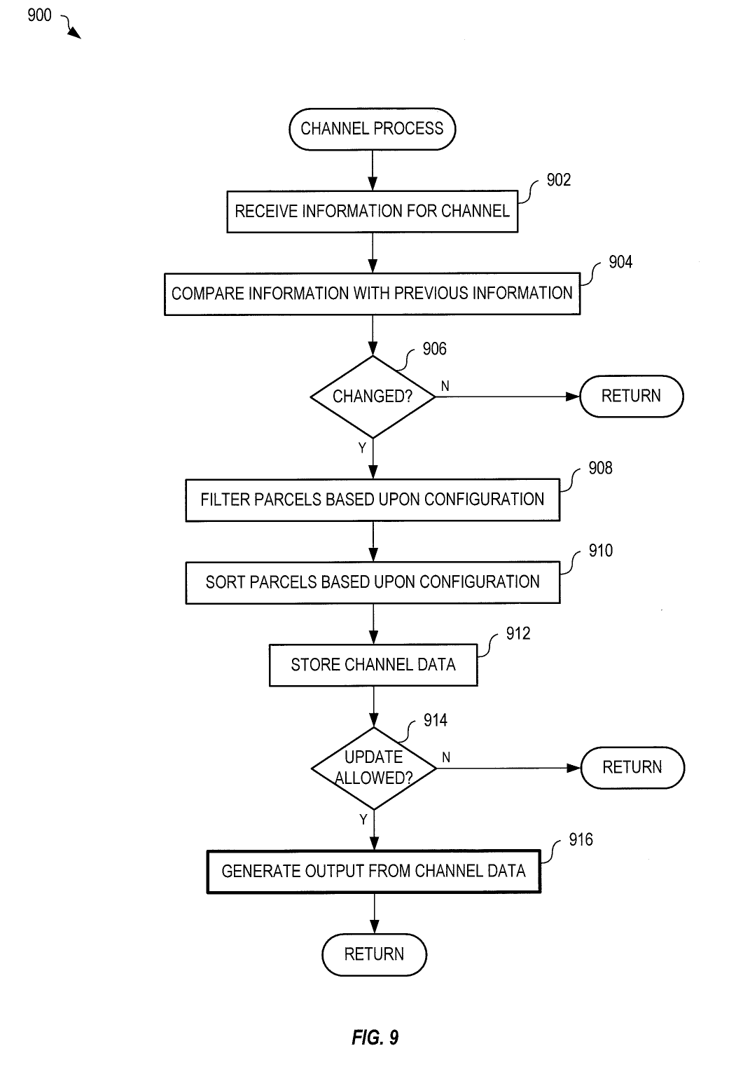

FIG. 9 is a flowchart illustrating one exemplary process 900 for generating a flattened display. Process 900 is for example implemented within SS application 514. In step 902, process 900 receives information for a channel. In one example of step 902, SS application 514 receives channel information from dongle 510 via USB port 516.

In step 904, process 900 compares the received information with previously received information. In one example of step 904, SS application 514

The technology of this disclosure employs the term “surface software” because it operates to re-render information shown on a display (e.g., a computer screen). In an embodiment, this re-rendered information is chosen in accordance with preference (e.g., personal preference, preference of the workplace, etc). For example, a user simply may never wish to see advertisements—and the surface software may be configured to stop advertisements. In another example, a user may wish never to see unwanted newsfeeds or daily postings by people through social networks; the surface software may thus operate to obscure or remove such data so that it does not clutter your display of quality information. In a specific example, a user can select a mode such as “workplace” and automatically filter data throughput to data associated with a workplace (of course, the workplace too can beneficially demand that data be associated with workplace too). In another embodiment, this re-rendered information is chosen automatically through interaction with underlying software (e.g., social network applications, news feed applications, etc.). For example, the surface software may be set to monitor and determine the user of a particular computer never views a particular newsfeed; the re-rendered information thus is automatically devoid of such information in an embodiment hereof.

A user's interaction with a display (e.g., with a mouse or keyboard) operates normally. When an interaction occurs with a re-rendered display (made possible by surface software), the interaction is translated to underlying windows (e.g., email, browser, social networks) so that a user can appropriately interact with the application of choice. In an embodiment, a user can select to view ‘native’ applications instead of the re-rendered screen at any time.

SS limits display of information from each background application: e.g., two items from twitter, two items from social networks, three email messages, etc. Conventionally, the applications update as they find new stuff to display, and it can all happen at once. SS prevents more than one area from changing at once. I.e., one new social networking message pops in, then one tweet message pops in a defined period later. The areas can be prioritized, such that social networking is more important, and gets the priority to update over tweets, but is still limited as to when it can update. This prevents overload of the user when too much information is changing on the screen. Obviously, foreground applications, such as word processor, spreadsheets, and so on, get the focus and update as needed.

In one example of operation, all applications that provide information are run on the PC in full screen mode, and the system switched between each application to retrieve information being displayed and to control them. The user doesn't see this switching, but instead sees the flat controlled output of the SS system.

In one embodiment, eye motion is detected to determine a user's desired priority of presented information. In another embodiment, brainwaves are used for determining a user's desired priority of presented information.

An incorporated eye movement detector allows the user to request updates to the displayed information wherein SS may display buffered information from the associated information source, or may request updated information from that information source. SS still filters and prioritizes the information, but may change the priority of the displayed information based upon the user's eye movement or brainwaves.

In one embodiment, brainwaves are monitored to determine if the user is ‘overloaded’ with information, wherein SS controls the update rate of information on the flat screen. I.e., the update rate and the amount of information presented to the user is based upon monitored eye movement and detected brainwaves.

At the Graphics Systems Level

All systems calls from the relevant applications to the graphics system may be intercepted by an SS application running within the computer. This is similar to the dongle approach but without the need for a piece of hardware or OCR. The SS application stops other application from cluttering up the display. SS application may be configured to operate in a wide range of contexts, such as smart phones and other intelligent devices with displays.

Data Stream

The SS application may be extended to intercept data passing between other applications and their servers, e.g. by intercepting the HTML stream for applications using a browser.

Application Mimic

In one embodiment, the SS application provides an alternative and composite user interface for all other applications running on the computer. Where appropriate, the SS application interrogates the relevant serve as if it was the real application. For example, the SS application may determine application setting from the application configuration files and database. This is for example useful with applications such as email.

Other Considerations

Most applications require user interaction before displaying a full range of data; the SS application operates to automate this data acquisition process before filtering and prioritizing the returned information.

When a dongle is used to acquire displayed information, it may also provide encryption functionality, thereby enhancing security of the computer.

In one example of operation, through use of the eye tracking device, the SS application may filter and/or remove information that the user does not spend time looking at. For example, emails from certain people may be substantially ignored, whereas other important messages may be read in detail. The SS application includes software that “learns” what types of information the user is interested in and what types of information the user ignores and filters it out. In another example, the SS application learns which authors/senders of email messages are of interest to the user, and which are not. The SS application then automatically filters out the email messages that do not interest the user.

The SS application may operate to reorder, and filter, data from all window displays and selected information sources. The SS Application (in one embodiment) flattens this information and displays information within a single window, such that it is easier for the user to follow and digest.

When the user is using other application (e.g., word processors, spreadsheets, etc.) the SS window (containing the filtered and reordered information) may be hidden or removed from the user's display. However, this information may be displayed upon command from the user (e.g., using one or more of keystroke, mouse, brainwave detector, and eye movement detector).

The SS application may select the amount of (important) data to display. Recent studies indicate, for example, that limiting the displayed information to “7” items (e.g., seven items per article, or seven pieces of information) is optimal for not overloading the human brain.

The SS application may also operate as a high level time manager. The SS application may determine which windows are used and/or viewed the most, which application the user has open, when the user is in the office, using the phone, and may track when the user is attentive to the computer (working) or not. The SS application integrates “integrates” this collected data to populate a time tracking database to provide “instant” bills (for lawyers and consultants, etc.) that reflect the time spent working much more accurately. The SS application may integrate with other applications such as email wherein it associates time management for a particular email with a particular client and thereby knows where to apply the time spent reading and responding to each email.

Where the SS application is running on a PC, it may optionally be implemented as a screen saver, wherein display of the user selected information from one or more information sources is displayed only when no activity on the PC is detected for a defined period.

In one embodiment, the SS application replaces ads and unwanted data that would normally be displayed by an application with serene scenes or more important data. The SS application may display detected logos from web sites for example, as a defined smaller symbol. Thus, where information is presented to the user, the SS application may include a symbol to indicate the source without displaying the full logo or associated graphic typically found on web sites.

Corporations may use the SS application to reconfigure screens, limit uses, and track real productivity of employees using computers in the office.

The SS application may also provide parental control over displayed information.

The SS application may provide the “last ads” for the display and take over all ad revenue of the other companies.

The displayed screen of the SS application may be ‘swiped’ away easily to get to underlying applications and data. For example, using the mouse, touch screen, eye movement, and/or brainwaves.

The SS application may be implemented with intelligence, such as a neural net, that learns what the user “sees” as important. Over time, operation of SS improves in filtering and ordering information based upon the user's desires. The SS application may provide a selectable display of information that has been filtered out, such as in a “high level” form, thereby allowing the user to “un-filter” items if desired.

The SS application may operate on one or more platforms such as a computer screen, an iPad, a smart phone, and may cooperate between multiple devices used by the same user, and be based upon the user's current status and/or location.

When the SS application is implemented in a dongle, a more restrictive control of displayed information may be provided. This restrictive approach may be more useful to provide parental control of a device used by minors. In another example, a computer used at work may use the SS application to provide a more restrictive control of information displayed by the computer. Since the dongle is a self-contained device, it is not easily tampered with, and may include recognition software to stop access to unauthorized sites.

In one embodiment, the SS application processes HTML received from an information source.

In one embodiment, the SS application interface is implemented in the cloud, and doesn't control the PC. The SS application is a service that is configured with access information of selected information sources (e.g., email, social networking, news sources) and operates to access that service to retrieve information that is presented in a flat, filtered, ordered composite window within a browser on the PC. The SS application may be implemented as at least two different concepts—one controlling the PC entirely to make sure the screen is controlled, and the other to provide a controlled window onto data that is displayed by the PC.

One of the problems with a user's Internet experience is that everyone is trying to attract your attention with advertisements and other information which distracts the user from work. Advertisement in particular are designed to be very distracting in order to attract the user's attention. Information sources attempt to make their information the most noticeable to the viewer. For example, web pages usually contain bright colors, movement, and other attention attracting features that potentially distract the user from their intended operation. An information source that has certain desirable information, may often have other distractions present on the same display (e.g., web page). The SS application operates to filter out the distracting elements while allowing the desired information to be displayed.

### Another Embodiment

In an embodiment, a timing application integrates data from many sources—email application, cell phone database usage information, social networks, desktop phone (landline) data, application data (e.g., word processor, spreadsheet, presentation or other application usage) to automatically track time spent by the user to a particular project. Lawyers and consultants use all these sources all the time but yet still manually insert time to a database for billing purposes. This is inefficient and often inaccurate. Instead, the timing application integrates “use” and “time” data from these sources and collects time spent on the sources by making intelligent choices. For example, if a lawyer spends 25 minutes writing an Outlook email to a client, that time is automatically clocked to that client by noting the time with which the user was active with the Outlook window. If that same lawyer also calls that client by cell, that time too is aggregated and added to the client's time billing. Often databases of modern law firms include data files (e.g., word processing documents) linked to a particular client or matter; the timing application also track the use and time spent on each such data file and attribute the time spent by the user, automatically, to the particular client associated with that file. Later of course the lawyer can review all charges and decide to bill the time or not, but at least the time is collected efficiently.

In another embodiment, the SS application “flattens” a user's experience. Interaction with the display simultaneously activates and interacts with separate application windows (e.g., email, social network, word processor, browser). The flatness simplifies the user experience, making the user more productive.

SS may utilize eye tracking to determine which particular information the user is assimilating, and thereby track time spent by the user on that information. Where this information is associated with a project, the user's time may be booked to that project.

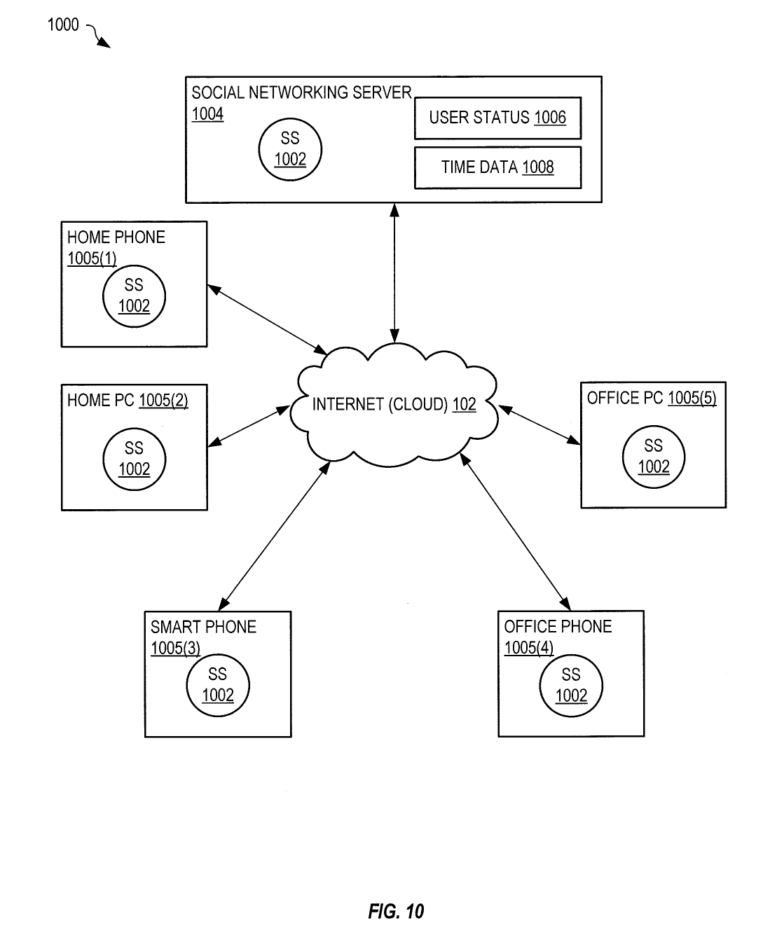

FIG. 10 shows one exemplary configuration 1000 wherein an SS application 1002 is installed on multiple devices 1005 and cooperates with a social networking server 1004. An SS application 1002 is, for example, included within the social networking server 1004. The social networking server 1004 maintains a user status 1006 for a user of SS application 1002, which is in turn used by the SS applications and software implementations to control the user experience. For example, the user status 1006 may indicate that the user is at home, such that an SS application/module 1002 within the user's home computer may automatically be configured to provide a suitable flat display for the user's viewing at home. Similarly, when the user is at his office of work, the user status 1006 within the social networking server 1004 may indicate “at work” wherein the SS modules/applications 1002 are automatically configured within the office PC to limit the information displayed within the SS flat display as suitable for the office environment.

In one embodiment, corporate policy may dictate the information that may be displayed by the SS application to the user while the user is at work.

In another example of operation, each SS application/module may send information to the social networking server 1004 indicating the activity of the user. Where this information indicates an operation that is associated with a billable function, such as when having a conversation with a client on the office phone or smart phone for example, time data 1008 may be recorded within the social networking server 1004. In another example, when the user is working on the office PC to read an email from the client, SS module./application 1002 may send that information to the social networking server 1004. In another example, where the user is working within a word-processing application on a file that is associated with the client, SS module/application 1002 may send information of the file and time spent within the word-processing application to the social networking server 1004. The social networking server 1004 may process the time data 1008 to generate a detailed time breakdown of the user's activities, which may then be used to accurately determine the time spent working on particular clients. Since the SS module/application 1002 is also operating on other devices used by the user, when work is performed outside the office, this time may also be accurately tracked within the social networking server 1004.

In another embodiment, the time data is collected within the social networking server 1004, and then sent to the SS application 1002 for determining appropriate allocation of the time to billing matters.

In one embodiment, where the SS application 1002 includes input from an eye tracking device, the amount of time spent by the user on information displayed on the personal computer may be accurately tracked, such that time is allocated to billing matters associated with that information. For example, although the user has a word processing window open on the office display, his attention may be focused on a different part of the screen, which is associated with a different client, or with non-billable information.

In one embodiment, a time keeping application and/or module is inserted into one or more of a mobile phone (e.g., as an app), an email program, a word processor, a spreadsheet program, a database program, and other software applications and devices. The time keeping module operates to determine a client associated with the work being performed by the software and devices when used by the user. Optionally, the module collect data associated with the user activities, and the client is determined later. In one example of operation, when the user is reading an email from a particular person, the time keeping module may determine a client associated with that person, such that time spent by the user within the email program on that particular email is billed to the appropriate client. Each time tracking module communicates with a server (e.g., a social network server) where the tracked time information is stored. The stored time information is processed (e.g., within the server, and/or exported to a separate program for processing) to determine billing information for the user.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. A method for tracking and billing time, comprising:
automatically linking email usage to a particular client and determining billable time associated with that email usage;
automatically linking phone usage to a particular client and determining billable time associated with that phone usage;
automatically linking document usage to a particular client and determining billable time associated with that document usage; and
automatically entering billable times into time management software to create client invoices or reports.

2. The method of claim 1, wherein automatically linking email usage comprises searching for names of clients within an email and associating those names to appropriate clients and/or billing codes.

3. The method of claim 1, wherein automatically linking phone usage comprises associating a telephone or cell phone with an appropriate client and/or billing code.

4. The method of claim 1, wherein automatically linking document usage comprises associating a word, excel or other document to an appropriate client and/or billing code.

5. The method of claim 1, wherein linking phone usage comprises utilizing local application within a cell phone that is tied to modules at a desktop or time management software.

6. Surface software interface, for controlling data output to a computer device, comprising:
means for collecting data from one or more applications running at the computer device; and
means for reconfiguring displayed output of some of the data on a screen of the computer device.

7. Surface software interface of claim 6, wherein the means for collecting comprises image grabbing and image interpretation software.

8. Surface software interface of claim 6, further comprising an eye monitoring device to determine which of the applications is being reviewed as well as which data is deemed important by a user of the computer device.

9. Surface software interface of claim 8, wherein means for reconfiguring comprises means for filtering out data deemed unimportant by the user.

10. Surface software interface of claim 6, wherein means for reconfiguring comprises means for filtering out advertisements of the applications.

11. Surface software interface of claim 6, wherein means for reconfiguring comprises means for flattening data from the multiple applications as the displayed output.

12. Surface software interface of claim 11, wherein the flattened data takes form as adjacent panels of data shown in the displayed output.

13. Surface software interface of claim 6, further comprising a physical plug connected to the graphics drive, to facilitate collection and reconfiguration of data for the displayed output.

14. Surface software interface of claim 6, wherein means for reconfiguring comprises means for determining data from applications which is superfluous from a user of the computer device, said superfluous data including data which the user skips through quickly.

15. Surface software interface of claim 6, further comprising means for displaying normal application displayed data in response to election by a user of the computer device.

16. Surface software interface of claim 6, further comprising enterprise management means for controlling each surface software interface on a network.

17. Surface software interface of claim 6, further comprising parental control means for controlling content permitted within the displayed output in response to user input at the computer device.

18. Surface software interface of claim 6, wherein the means for reconfiguring comprises means for linking logos from the applications to the displayed output, so a user of the computer device appreciates which part belongs to an underlying application.

19. Surface software interface of claim 6, further comprising productivity means for tracking usage within any one application or data of any one application, for linking to time management software.
